(19) United States
(12) Patent Application Publication
(10) Pub. No.: US 2026/0099854 A1
(43) Pub. Date: Apr. 9, 2026

(54) ITEM TRACING AND AUTHENTICATION TECHNIQUES

(71) Applicant: eBay Inc., San Jose, CA (US)

(72) Inventor: Richard CHANDRAGUPTHARAJAH, Fremont, CA (US)

(21) Appl. No.: 18/908,110

(22) Filed: Oct. 7, 2024

(51) Int. Cl. G06Q 30/018; G06Q 30/0601; G06V 30/10

(52) U.S. Cl. CPC G06Q 30/0185; G06Q 30/0639; G06V 30/10

(57) ABSTRACT

The technology described herein relates to systems, methods, and computer storage media, among other things, for generating and providing a journey profile for an item (e.g., an item offered on an ecommerce platform) that includes one or more authentication verifiers, and for generating and providing a visualization associated with the journey profile (e.g., a map visualization for item at a plurality of locations corresponding to a plurality of historical location identifiers). For example, the journey profile may be generated based on linking a unique item identifier of the item to the authentication verifier for the item (e.g., the authentication verifier corresponding to a certificate of authenticity or another form of authentication data that is based on a physical inspection of the item).

### BACKGROUND

Computing operations for determining whether an item is authentic (e.g., compared to items that are not authentic and made from cheaper materials and have an inferior construction, such as uneven stitching) may involve different techniques, as well as some challenges. For example, digital watermarks and serialization techniques for software packaging may sometimes be replicated or cloned by counterfeiters. As another example, particular algorithms, which are trained on images of authentic items and images of items that are not authentic, may not be capable of detecting items within images that are not authentic due to altered image pixels or noise pattern implementation that disrupts detection (e.g., as a result of counterfeiters manipulating image data).

### SUMMARY

At a high level, aspects described herein relate to systems, methods, and computer storage media for, among other things, generating and providing (e.g., by an item tracing and authentication engine) item journey profiles that include authentication verifiers (e.g., corresponding to an authenticity certification generated based on a physical inspection of the item, accessed based on operations of an authentication verification engine, etc.). By way of illustration, in some embodiments, a unique item identifier (e.g., a unique arrangement of one or more letters, numbers, symbols, etc. that corresponds to an item offered on an ecommerce platform) may be generated for the item based on receiving particular information for the item (e.g., a stock keeping unit, a universal product code, serial number, item description, an image of the item, etc.), and the journey profile for that item may be generated based on linking the unique item identifier to the authentication verifier. In some embodiments, the journey profile may include a plurality of locations in which the item has been physically located throughout a particular period of time.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment associated with the item tracing and authentication engine, in accordance with an embodiment described herein;

FIG. 2 illustrates an example flow diagram associated with generating item journey profiles and visualizations, in accordance with an embodiment described herein; and

FIG. 3 is an example client device suitable for implementing the described technology, in accordance with an embodiment described herein.

### DETAILED DESCRIPTION

Tracing items (e.g., items offered on an ecommerce platform) may include tracing a product from its listing on an e-commerce platform to a point of sale, through shipment (and back to the seller for a return or a dispute). Item tracing-identification of previous owners, identification of previous locations in which the items has been, a chain of title for the item, etc. may be challenging due to several factors. For example, a seller may provide an inconsistent or an inaccurate item description, which could make it difficult to trace this specific item. As another example, one seller may list a stock keeping unit for an item, and another seller may list a universal product code for an identical item, which can cause traceability issues. In yet another example, some sellers may use multiple accounts and may provide incorrect seller identity information, which may make it difficult to trace the source of a counterfeited item.

Some computerized systems lack tracing capabilities based on technological deficiencies. For example, some computerized systems are unable to maintain a unified database of item listings (e.g., based on fragmented data from multiple sources, such as item listings, customer reviews, seller profiles, purchase histories, external databases including brand registries, etc.), which complicates the tracing of items (e.g., complicating the identification of previous owners, complicating the identification of all the locations in which the item has been prior to purchase). For instance, current databases do not include particular data points (e.g., as provided by embodiments herein based on particular technological operations) to thoroughly and precisely trace particular items. In addition, the scaling of millions of items listings without thoroughly maintained databases can result in technological challenges for these computerized systems. For instance, without implementing proper computing operations to process large volumes of data quickly, the processing of these large volumes of data results in low throughput.

It is desirable (e.g., for both service platform providers and users of those services) to have systems that can trace items (e.g., the exchange of ownership across a lifetime of the item or across a particular portion of the lifetime of the item, each instance of authentication verifications of that item, each shipping origin and destination for that item, etc.) using technological operations that include thorough and precise traceability parameters, such that the maintenance of a unified database and access to that database, as well as enhanced utilization of computing resources, results in improvements to throughput and improvements to item tracing for a plurality of benefits associated with improved item tracing (e.g., faster detections of counterfeits, improved counterfeit detection, lower detections of false non-counterfeits, etc.).

The present technology disclosed herein provides for improvements to a computer and computing operations performed by the computer, and further provides an improved technological implementation of item authentication. For example, the disclosed technological operations include thorough and precise traceability parameters for items, such that computing components are capable of processing large volumes of data quickly and without low throughput and high latency (e.g., based on the precise traceability parameters, the authentication verifiers generated, the authentication verifiers being accessible in the database), thereby enhancing utilization of computing resources. The generation of the authentication verifiers and electronic storage thereof provides for improvements to recall information, thereby leading to improved performance of applications, databases, and file retrieval systems. As another example, the technology disclosed herein provides for faster detections of counterfeits, improved counterfeit detection, lower detections of false non-counterfeits, etc.

A technology suitable for performing these technological improvements is described in more detail with reference to the drawings. It will be understood that additional systems and methods for providing network management services can be derived from the following description of the technology.

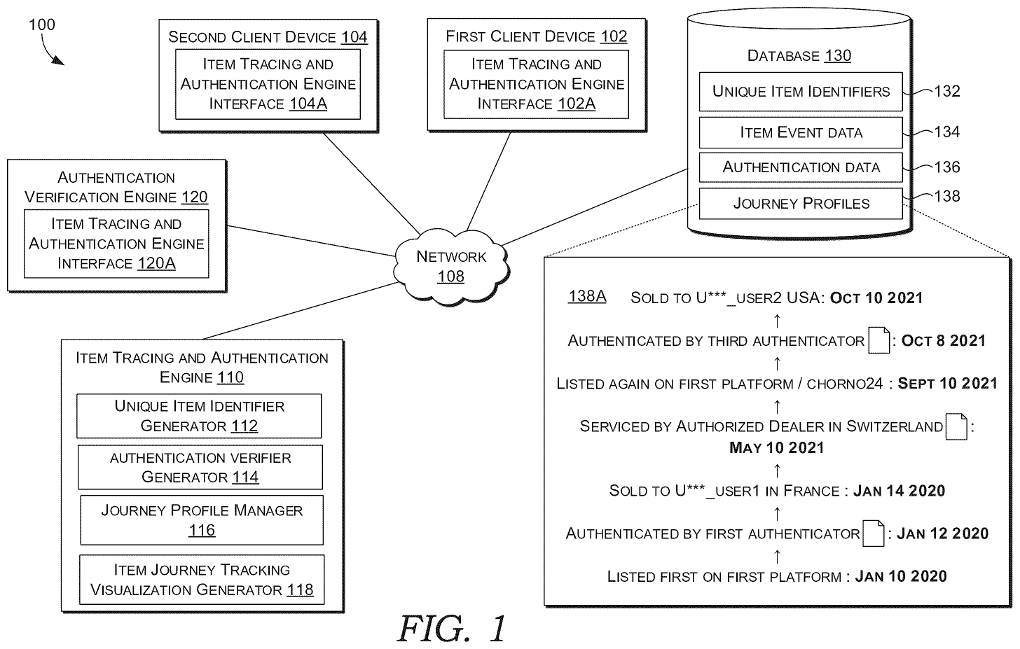

Turning now to FIG. 1, FIG. 1 illustrates an example operating environment 100 in which implementations of the present disclosure may be employed. In particular, FIG. 1 illustrates a high-level architecture of example operating environment 100 having components in accordance with implementations of the present disclosure. The components and architecture of FIG. 1 are intended as examples, as noted toward the end of the Detailed Description.

Example operating environment 100 includes a first client device 102 having an item tracing and authentication engine interface 102A; a second client device 104 having an item tracing and authentication engine interface 104A; network 108; item tracing and authentication engine 110 having unique item identifier generator 112, authentication verifier generator 114, journey profile manager 116, and item journey tracking visualization generator 118; authentication verification engine 120 having item tracing and authentication engine interface 120A; and database 130 having unique item identifiers 132, item event data 134, authentication data 136, and journey profiles 138 including example journey profile 138A. Other embodiments of example operating environment 100 may include additional authentication verification engine(s), additional client device(s), etc.

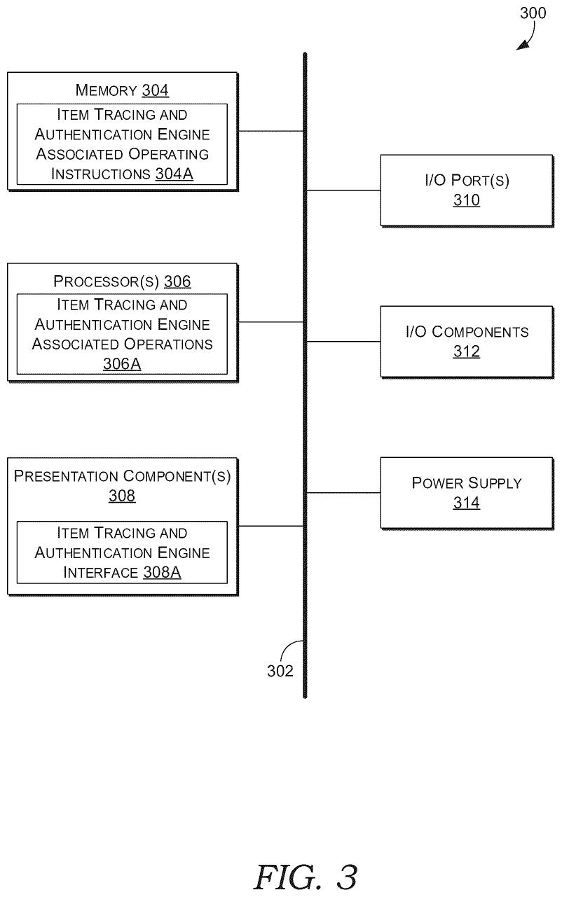

The first client device 102 and the second client device 104 may be a device that has the capability of accessing the network 108, and may also be referred to as a “computing device,” “mobile device,” “client device,” “user equipment (UE),” “communication device,” etc. In some embodiments, the authentication verification engine 120 may also be, or include, a client device. The first client device 102 may, in some embodiments, take on a variety of forms, such as a personal computer, a laptop computer, a tablet, a mobile phone, a personal digital assistant, a wearable device, a server, or any other type of device that is capable of communication (e.g., by transmitting or receiving a signal) using the network 108. Broadly, a client device can include computer-readable media storing computer-executable instructions executed by at least one computer processor. One example of a client device includes client device 300 described herein with reference to FIG. 3. A client device may be operated by a user, such as one or more of a person, machine, robot, another user device operator, or one or more combinations thereof.

As illustrated in example operating environment 100, the first client device 102, second client device 104, and the authentication verification engine 120 may be capable of communicating with the item tracing and authentication engine 110 over the network 108 (e.g., based on the item tracing and authentication engine interface 102A, the item tracing and authentication engine interface 104A, and the item tracing and authentication engine interface 120A). In some embodiments, the first client device 102 is associated with a seller interface (e.g., associated with an e-commerce platform), and the second client device 104 is associated with a buyer interface. In some embodiments, the second client device 104 can also cause the display of image data, text data, extended reality data, other types of data, or one or more combinations thereof (e.g., via the item tracing and authentication engine interface 102A and based on operations of the item tracing and authentication engine 110, the operations associated with the unique item identifier generator 112, authentication verifier generator 114, the journey profile manager 116, and the item journey tracking visualization generator 118).

In embodiments, the network 108 may include one or more of a local area network (LAN), a wide area network (WAN), a mesh network, a hybrid network, a plurality of networks, another type of network, or one or more combinations thereof. In some embodiments, one or more of the first client device 102, the second client device 104, the item tracing and authentication engine 110, or the authentication verification engine 120, may communicate over the network 108 via the Internet or another public or private network. In some embodiments, one or more of the first client device 102, the second client device 104, or the authentication verification engine 120, may be connected to the network 108, or a portion thereof, for communication(s) associated with the item tracing and authentication engine 110 based on their respective item tracing and authentication engine interface. Other embodiments of example operating environment 100 may include additional client devices or network components that are capable of communicating (e.g., transmitting or receiving) with the item tracing and authentication engine 110.

In embodiments, operations of the item tracing and authentication engine 110 may be implemented by a server (e.g., one or more computing devices). In embodiments, server implementing the operations of the item tracing and authentication engine 110 may represent a backend or server-side device. In some embodiments, the implementing the operations of the item tracing and authentication engine 110 may be an edge server. In embodiments, the item tracing and authentication engine 110 may receive requests or transmissions from the first client device 102, the second client device 104, or the authentication verification engine 120, and may coordinate fulfillment (or denial) of those requests or transmissions (e.g., sometimes through other additional servers).

In embodiments, the authentication verification engine 120 may comprise one or more of a client device, a multi-processor system, a server, etc. In some embodiments, the authentication verification engine 120 may provide authentication data to the item tracing and authentication engine 110, which is to be stored at authentication data 136 of the database 130. In embodiments, the item tracing and authentication engine 110 generates authentication verifiers (e.g., a unique arrangement of one or more letters, numbers, symbols, etc. that corresponds to the authenticity of an item offered on an ecommerce platform, hashes, digital signatures, etc.) using the authentication verifier generator 114 based on the authentication data provided by the authentication verification engine 120. In embodiments, an authentication verifier may be generated for a certificate of authenticity, a Gemological Institute of America certification (e.g., for jewelry and gemstones), a National Association of Watch & Clock Collectors certification, etc., or one or more combinations thereof.

In embodiments, the authentication data provided to the item tracing and authentication engine 110 by the authentication verification engine 120, which may be stored at authentication data 136, may comprise electronic authentication verification data or documentation (e.g., generated based on a physical inspection of the item) or other types of authentication verification information, etc. For example, an item (e.g., a luxury good, sneakers, watch, trading cards, electronics, jewelry, handbags, coins, collectables, etc.) may be physically inspected by an authenticator (e.g., an authenticator other than a seller or buyer of an item), and the authentication data generated or determined from the inspection may be transmitted, from the authentication verification engine 120, to the item tracing and authentication engine 110. In embodiments, the authenticator may be a human expert having particular certifications. In some embodiments, image recognition software, infrared light, ultraviolet light, microscopy techniques, radio frequency identification tags, near field communication, or blockchain technology may be used to generate the authentication data stored as the authentication data 136.

In some embodiments, the authentication data 136 may comprise a certificate of authenticity, a Gemological Institute of America certification (e.g., for jewelry and gemstones), a National Association of Watch & Clock Collectors certification, a National Institute of Watchmaking certification, a certification associated with a particular brand, a Professional Sports Authenticator certification or a Distinctive Numerical Authentication certification for sports memorabilia, trading cards, or autographs, a Beckett Authentication Services certification for autographs, sports memorabilia, or trading cards, a Sneaker Con Legitimacy Program certification, an International Gemological Institute certification associated with gemology, diamond grading, or jewelry design, an American Numismatic Association certification for coins or currency, a textile analysis certification, a Certified Forensic Document Examiner certification for collectibles or autographs, a Certified Information Systems Security Professional certification or Certified Digital Forensics Examiner certification for digital assets or digital records, a Certified Auctioneer Institute certificate for art, antiques, or collectibles, a Brand Protection Professional certificate, a American Society of Appraisers certificate, a Uniform Standards of Professional Appraisal Practice certificate, other types of certifications, etc., or one or more combinations thereof.

In embodiments, the authentication verifier generator 114 generates authentication verifiers (which may be stored in authentication data 136) based on one or more of the particular certificates above. In other embodiments, the item tracing and authentication engine 110 receives authentication verifiers from the authentication verification engine 120. By way of example, the authentication verifier generator 114 may generate authentication verifiers (e.g., a unique arrangement of one or more letters, numbers, symbols, etc. that corresponds to the authenticity of an item offered on an ecommerce platform, hashes, digital signatures, etc.) using one or more models (e.g., a convolutional neural network that generate code based on image pattern recognition, an anomaly detection model, a generative adversarial network, a natural language processing model, an adaptive coding algorithm), a sensor-based code generator (e.g., an internet-of-things device), a software application, one or more computer processing units, a web-based code generator, a cloud-based code generator, embedded processors, radio frequency identification technology, near field communication technology, dynamic code generation, data synchronization and real-time updating of authentication verifiers, blockchain updating of the authentication verifiers, edge computing devices, etc., or one or more combinations thereof.

In embodiments, the journey profile manager 116 may link the authentication verifiers to unique item identifiers for items (e.g., items corresponding to item listings on a platform). The unique item identifiers may be generated by the unique item identifier generator 112 using item-specific features (e.g., a description of an item provided by a seller client device, a stock keeping unit, a universal product code, a European article number, an international standard book number, global trade item number, price look-up code, a product unique web address, a quick response code, a serial number, unique data associated with an embedded chip or tag, unique product code, batch or production code, images of the item provided by the seller client device, etc.). The unique item identifiers generated by the unique item identifier generator 112 may be stored in the unique item identifiers 132 of the database 130.

The journey profile manager 116 may link the authentication verifiers within authentication data 136 to unique item identifiers 132 in the database 130 by using one or more primary and foreign key relationships, one-to-one relationships, one-to-many relationships, many-to-many relationships, self-referencing relationships representing hierarchical data, composite keys, index-based linking, partitioning, de-normalization techniques, relational database linking, application programming interface integration, message queues, event streaming, extract transform and load tools, micro-services architecture, service-oriented architecture, virtual data layers, function-as-a-service, multi-cloud data management tools, graph databases, blockchain integration, etc., or one or more combinations thereof.

Based on linking an authentication verifier to a unique item identifier (e.g., a first authentication verifier and a second authentication verifier to a first unique item identifier), the journey profile manager 116 may generate a journey profile (e.g., for providing particular electronic authentication documentation, such as generated by the authentication verification engine 120 based on a physical inspection of an item). The journey profile manager 116 may generate a journey profile for various items (e.g., the journey profile including the authentication verifier, authentication documentation associated with the authentication verifier, etc.) based on linking a particular authentication verifier to a particular unique item identifier. In embodiments, the journey profile (e.g., journey profile 138A) may be displayed on interfaces of a user device (e.g., the item tracing and authentication engine interface 104A of the second client device 104), so that the user of the user device may make a more informed purchasing decision.

For example, the journey profile manager 116 may generate example journey profile 138A (stored within journey profiles 138 of the database 130), which includes a series of item event data (e.g., stored as item event data 134) comprising a date (e.g., Jan. 10, 2020) of a first listing on a first ecommerce platform, a date (e.g., Jan. 12, 2020) of a first authentication verification by a first authenticator and a first authentication document, a date (e.g., Jan. 14, 2020) of a first transaction of the item and a location of the subsequent owner of the item, a date (e.g., May 10, 2021) of a second authentication verification by a second authenticator and a second authentication document, a date (e.g., Sep. 10, 2021) of a second listing on the first ecommerce platform, a date (e.g., Oct. 8, 2021) of a third authentication verification by a third authenticator and a third authentication document, and a date (e.g., Oct. 10, 2021) of a second transaction of the item and a second location of the next owner of the item.

In some embodiments, the first authentication document may be received from the authentication verification engine 120, the second authentication document may be received from a different authentication verification engine, and the third authentication document may be received from yet another authentication verification engine. In some embodiments, the example journey profile 138A may be generated based on linking authentication verifiers (e.g., a first authentication verifier for the first authentication verification, a second authentication verifier for the second authentication verification, a third authentication verifier for the third authentication verification) to a unique item identifier. For example, the example journey profile 138A may be generated for various types of items (e.g., vehicles, vehicle parts, vehicle accessories, a luxury good associated with a particular brand, sneakers associated with a particular brand, watches, trading cards, electronics, jewelry, handbags, coins, particular collectables, etc.).

By way of illustration, in embodiments wherein the item is a vehicle, vehicle part, or vehicle accessory, the unique item identifier may be generated by the unique item identifier generator 112 based on one or more of an Original Equipment Manufacturer Part Number, an Aftermarket Part Number, a Vehicle Identification Number Range Compatibility, Global Trade Item Number, a serial number, other types of item-specific features, etc., or one or more combinations thereof. In these embodiments, the authentication documents of the example journey profile 138A may include an Original Equipment Manufacturer certification (e.g., for an engine, transmission, brake component), an ISO certification (e.g., ISO 9001), Society of Automotive Engineers certificate (e.g., associated with quality, safety, performance, etc.), an Economic Commission for Europe certification, an E-Mark certification, Department of Transportation certification, Certificate of Conformity, emission certification, a National Highway Traffic Safety Administration certification, a Federal Aviation Administration certification for a drone, an ASTM certification, a warranty, a repair certification, a roadworthiness certificate, a repair report indicating the vehicle identification number description of the services performed, etc. In embodiments, the first authentication document, the second authentication document, and the third authentication document may be provided for display (e.g., on the item tracing and authentication engine interface 104A of the second client device 104) based on receiving a selection (e.g., of an icon on the example journey profile 138A).

In embodiments, the journey profile manager 116 may generate a journey profile using item event data 134. For example, item event data 134 may include historical listing data on an ecommerce platform (e.g., a user-provided description of the item, user-provided images of the item), manufacturer-provided information about the item, historical shipment data for the item, historical repair data of the item, historical transaction data of the item, historical owner information, historical location data for the item, historical blockchain data for the item, historical Radio Frequency Identification data for the item, historical Near Field Communication data for the item, short-range wireless technology data for the item, Global Positioning System data for the item, other types of item event data, etc., or one or more combinations thereof. Each of these item events may have a unique item event identifier that is stored within item event data 134, which may be linked with the unique item identifier for a corresponding item for generating journey profiles.

In some embodiments, the journey profile manager 116 may use location identifiers for the item and link them to the unique item identifier, so that the location identifiers may be included in the journey profile. For example, the location identifiers may correspond to latitude, longitude, satellite location data, universal transverse Mercator coordinates, shipping addresses, geohashes, internet protocol addresses, media access control addresses, cell tower identities, warehouse and inventory location identifiers, internet-of-things location identifiers, beacon universal unique identifiers, United Nations Code for Trade and Transport Locations coding scheme, International Civil Aviation Organization code, Near Field Communication data, Radio Frequency Identification (RFID) data, short-range wireless technology data, other types of location data, etc., or one or more combinations thereof.

In embodiments, the location identifiers may be linked to the unique item identifier upon the item tracking and authentication engine 110 verifying that the location identifiers correspond to a physical location of the item. For example, the item tracking and authentication engine 110 may compare shipping data associated with the item to RFID data from the physical item using RFID tracking software. As another example, internet-of-things location tracking and cell tower triangulation may be used to verify the location identifier for the item. As another example, Wi-Fi location tracking may be used to detect a particular Wi-Fi network that the item is connected with to verify the location identifier for the item. In yet another example, a beacon of the item may measure the signal strength or proximity to fixed beacons, and the item tracking and authentication engine 110 may use the signal strength measurement(s) to verify the location identifier.

In embodiments, the item journey tracking visualization generator 118 may provide a map visualization that illustrates the item at a plurality of locations (e.g., at different cities, at different areas within different countries) corresponding to the location identifiers. In some embodiments, for example, the map visualization may be a choropleth map that includes different shading or colors representing the length of time that the item was at that particular location. As another example, the map visualization may be a dot distribution map having dots that represent the locations in which the item has been. In some embodiments, the dot distribution map may include elevation and terrain features. In some embodiments, the map visualization may provide indications of changing borders of a country over time, in embodiments wherein the item was located within a country that has changed borders during or after the item was located within that country during the item's journey profile lifetime. In some embodiments, the map visualization may be a flow map representing the item's journey during shipments associated with the item's journey profile. In some embodiments, the map visualization may be displayed using augmented reality, extended reality, etc. (via smart glasses or smart headsets).

In embodiments, item tracing and authentication engine 110 may comprise client devices (e.g., client device 300 of FIG. 3). In some embodiments, the item tracing and authentication engine 110 may be single server, a distributed computing environment encompassing multiple computing devices located at the same physical geographical location or at different physical geographical locations, another type of server environment, etc. In some embodiments, the item tracing and authentication engine 110 can connect to the database 130 or, in other embodiments, the item tracing and authentication engine 110 can be in communication with a plurality of servers that each share the database 130 or that each have their own database. In embodiments, the item tracing and authentication engine 110 is a backend or server-side device. It will be understood that some implementations of the technology will comprise either a client-side or front-end computing device, a backend or server-side computing device, or both executing any combination of functions associated with example operating environment 100, among other functions or combination(s) of functions.

### Example Flow Diagram

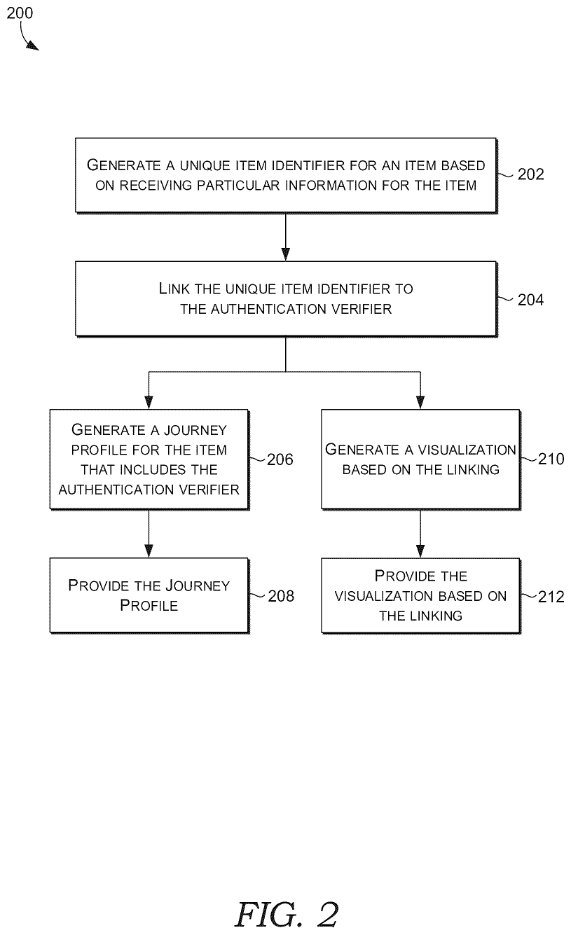

FIG. 2 depicts an example flow diagram 200 having step 202 that begins with generating a unique item identifier for an item based on receiving particular information for the item. In embodiments, the information for the item may be received by a client device (e.g., the first client device 102 of FIG. 1, a seller device, etc.). The information for the item may include one or more of an item description for an item listing, an actual image of the item, a stock image of the item, a title for the item, a brand of the item, a color of the item, material of the item, a universal product code, a European article number, weight and dimensions, etc., or one or more combinations thereof. In some embodiments, the item tracing and authentication engine 110 of FIG. 1 may receive the information for the item and may generate the unique item identifier and store the unique item identifier in unique item identifiers 132 of the database 130. In some embodiments, the item tracing and authentication engine 110 of FIG. 1 may identify and retrieve the unique item identifier upon certain triggers (e.g., upon the second client device 104 querying or selecting the item, upon a buyer client device querying or selecting the item, etc.).

Step 204 comprises linking the unique item identifier to an authentication verifier. In some embodiments, the authentication verifier may be received by the authentication verification engine 120 of FIG. 1. In some embodiments, the authentication verifier may be generated by authentication verifier generator 114 of FIG. 1 based on receiving authentication data from the authentication verification engine 120, and the authentication data and the authentication verifier may be stored in authentication data 136 for subsequent identification and retrieval by the item tracing and authentication engine 110.

In some embodiments, a second set of authentication data for the item may be received (e.g., received from the authentication verification engine 120, from a second authentication verification engine, from a seller client device, etc.), and a second authentication verifier may be generated and stored for subsequent identification and retrieval. In some embodiments, a third set of authentication data for the item may be received (e.g., received from the authentication verification engine 120, from a third authentication verification engine, from the seller client device, etc.), and a third authentication verifier may be generated and stored for subsequent identification and retrieval. Each authentication verifier may be linked to the unique item identifier.

In some embodiments, the item tracing and authentication engine 110 may determine that one of the sets of authentication data has missing authentication data for the item. For example, the authentication data received may include a certification for a collectible or autograph from a Certified Forensic Document Examiner, and the certification received may be missing an indication of the set number of years of experience of the document examiner or a missing date of the certification. As another example, the authentication data received may include a National Association of Watch & Clock Collectors certification, and the certification for a watch item may be missing the serial number for the watch or an overall condition for the watch. In yet another example, the authentication data received may include a Society of Automotive Engineers certificate, and the certification for a vehicle part may be missing a part identification number or testing and compliance data.

In embodiments, the item tracing and authentication engine 110 may determine that one of the sets of authentication data has missing authentication data by applying a convolutional neural network to detect objects (e.g., a signature object) within an image of the certification, semantic segmentation of the image of the certification, anomaly detection (e.g., via an autoencoder or isolation forest) within the image of the certification, named entity recognition for missing entities within an electronic document of the certification, rule-based gap detection to an electronic document of the certification, topic modeling (e.g., Bidirectional Encoder Representations from Transformers) to an electronic document of the certification, document similarity and template matching, etc., or one or more combinations thereof. In embodiments, the item tracing and authentication engine 110 of FIG. 1 may provide an indication of the missing authentication data (e.g., to the authentication verification engine 120, to a buyer client device, etc.).

Step 206 comprises generating a journey profile for the item (based on linking the unique item identifier to the authentication verifier), the journey profile including the authentication verifier; and step 208 comprises providing the journey profile (e.g., to a display of a client device of a potential buyer, e.g., such as one or more presentation components 308 of FIG. 3). In some embodiments, the journey profile may include a plurality of historical locations or a plurality of historical location identifiers based on linking the unique item identifier to each of the plurality of historical location identifiers. In embodiments, the historical locations or historical location identifiers may be determined based on item event data 134 of FIG. 1. For example, the example journey profile 138A of FIG. 1 includes a plurality of historical locations (e.g., a buyer/user in France, an authenticator in Switzerland, a second buyer/user in USA). As another example, a vehicle that is an item may have a plurality of historical locations associated with each of the following item events: manufacturing facility location, location of an initial dealership, an initial owner home location, a location of a subsequent sale, a location of a subsequent owner, locations at which the vehicle was repaired, locations at which the vehicle received maintenance, locations at which a vehicle part having a particular part identifier was installed, replaced, or repaired, etc. Each of these item events may have a unique item event identifier that is linked with the unique item identifier for that item.

By way of illustration, the item event data may include item repair data, item manufacturing data, item appraisal data, item maintenance data (e.g., an oil change of a vehicle item, a tire rotation of a vehicle item, software updates of an electronic item, cleaning and polishing of a jewelry item, calibration of an instrument item, tuning of a musical item, etc.), item restoration data, item upgrading or customization data (e.g., updating a hard drive for an electronic item, an installation of a vehicle accessory for a vehicle item), item resale data, damage assessment data, etc., or one or more combinations thereof. As such, historical location data may be stored with each of its corresponding item event data for including the historical location data within the journey profile.

In some embodiments, the item tracing and authentication engine 110 of FIG. 1 may determine a gap in historical locations between at least two of the plurality of historical location identifiers based on the item event data, and may provide an indication of the gap in historical locations within the journey profile. For example, the item event data may include a sale of the vehicle to a first owner at a first location (e.g., country A), and the item event data may include a subsequent repair location of the vehicle at a second location that is above a threshold distance (e.g., country B). In other embodiments, gaps in historical dates may be determined (e.g., dates corresponding to two vehicle maintenance events (e.g., an oil change) may have a gap in time that is above a threshold), and an indication of the determined gap in historical dates may be provided within the journey profile.

In some embodiments, the item tracing and authentication engine 110 of FIG. 1 may determine a gap in historical ownership of the item between at least two of a plurality of previous owners (e.g., determined based on the item event data), and an indication of the gap in historical ownership of the item may be included within the journey profile. For example, the item event data may include a first sale of the item from owner A to owner B, and a second sale of the item from owner C to owner D (i.e., missing item event data related to a sale of the item from owner B to owner C). In embodiments, the gap in historical ownership may be determined by applying named entity recognition, a recurrent neural network, dependency parsing, anomaly detection, template matching, etc., or one or more combinations thereof, to the item event data.

Step 210 comprises generate a visualization for the item (based on linking the unique item identifier to the authentication verifier), and step 212 comprises providing the visualization (e.g., to a client device of a potential buyer). In embodiments, the visualization may be a map visualization that illustrates the item at a plurality of locations corresponding to the plurality of historical location identifiers. For example, the map visualization may be generated by item journey tracking visualization generator 118 of FIG. 1.

### Example Client Device

Having described an overview of embodiments of the present technology, an example operating environment in which embodiments of the present technology may be implemented is described below in order to provide a general context for various aspects. Referring initially to FIG. 3, in particular, an example operating environment for implementing embodiments of the present technology is shown and designated generally as client device 300. Client device 300 is but one example of a suitable computing environment and is not intended to suggest any limitation as to the scope of use or functionality of the technology. Neither should client device 300 be interpreted as having any dependency or requirement relating to any one or combination of components illustrated.

The technology of the present disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 3, client device 300 includes bus 302 that directly or indirectly couples the following devices: memory 304 (e.g., including item tracing and authentication engine associated operating instructions 304A), one or more processors 306 (e.g., including item tracing and authentication engine associated operations 306A), one or more presentation components 308 (e.g., including item tracing and authentication engine interface 308A), input/output ports 310, input/output components 312, and illustrative power supply 314. In some embodiments, client device 300 may be first client device 102 or second client device 104 of FIG. 1.

Bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component, such as a display device, to be an I/O component. As another example, processors may also have memory. Such is the nature of the art, and it is again reiterated that the diagram of FIG. 3 is merely illustrates an example computing device that can be used in connection with one or more embodiments of the present technology. Distinction is not made between such categories as “workstation,” “server,” “laptop,” “hand-held device,” etc., as all are contemplated within the scope of FIG. 3 and reference to “computing device.” Client device 300 typically includes a variety of computer-readable media. Computer-readable media can be any available media that can be accessed by client device 300 and includes both volatile and nonvolatile media, and removable and non-removable media. By way of example, and not limitation, computer-readable media may comprise computer storage media and communication media.

Computer storage media include volatile and nonvolatile, removable and non-removable media implemented in any method or technology for storage of information, such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by client device 300. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and other transmissions. Combinations of any of the above should also be included within the scope of computer-readable media.

Memory 304 includes computer storage media in the form of volatile or nonvolatile memory. The memory 304 may be removable, non-removable, or a combination thereof. Example hardware devices include solid-state memory, hard drives, optical-disc drives, etc. Client device 300 includes one or more processors that read data from various entities such as memory 304 or I/O components 312.

In embodiments, the item tracing and authentication engine associated operating instructions 304A, when used by the one or more processors 306, causes the one or more processors 306 to perform operations comprising the item tracing and authentication engine associated operations 306A. For example, the one or more processors 306 may include, in some embodiments, at least one microprocessor or microcontroller. As another example, the one or more processors 306 may include, in some embodiments, a central processing unit (CPU), a graphics processing unit (GPU), a system-on-chip (SoC), a neural processing unit (NPU), a digital signal processor (DSP), an image signal processor (ISP), a secure enclave processor, another type of processor, or one or more combinations thereof.

In some embodiments, the item tracing and authentication engine associated operations 306A may correspond to providing an interface (e.g., item tracing and authentication engine interface 308A) based on communications with one or more servers associated with the item tracing and authentication engine 110 of FIG. 1. By way of example, the item tracing and authentication engine associated operations 306A may be associated with an authentication verification system (e.g., authentication verification engine 120 of FIG. 1). As another example, the item tracing and authentication engine associated operations 306A may be associated with an e-commerce platform (e.g., an e-commerce application or webpage).

In some embodiments, the item tracing and authentication engine associated operations 306A may include providing information for an item to an item tracing and authentication engine, providing an authentication verifier for the item, receiving a journey profile for the item that includes the authentication verifier, receiving the journey profile that includes a first location identifier for the item, receiving the journey profile that includes a second location identifier for the item, receiving the journey profile that includes a third location identifier for the item, receiving the journey profile that includes a second authentication verifier for the item, receiving the journey profile that includes a third authentication verifier for the item, receiving the journey profile that includes a plurality of previous listings of the item on one or more platforms, receiving the journey profile that includes a plurality of historical owners of the item, displaying the journey profile, displaying a map visualization (e.g., from the journey profile) that illustrates the item at a first location corresponding to the first location identifier and at a second location corresponding to the second location identifier, receiving an indication that the item is a counterfeit, receiving an indication that the item is authentic, receiving an indication of a gap in historical ownership of the item, receiving an indication of a gap in historical locations of the item, receiving an indication of missing authentication information for the item, etc., or one or more combinations thereof.

Presentation component(s) 308 present data indications to a user or other device. Examples of presentation components may include a display device (e.g., a liquid crystal display or another type of display capable of rendering text or graphics, such as from web sites or applications), speaker, printing component, vibrating component, etc. In some embodiments, the item tracing and authentication engine interface 308A may provide a display based on one or more of a text-based signal, an audio signal, an image signal, etc., or one or more combinations thereof. In some embodiments, the item tracing and authentication engine interface 308A may display an authentication verifier, a journey profile, historical location data for the item, previous listings of the item on one or more platforms, historical owners of the item, a map visualization that illustrates the item at each of the historical locations, an indication that the item is a counterfeit, an indication that the item is authentic, an indication of a gap in historical ownership of the item, an indication of a gap in historical locations of the item, an indication of missing authentication information for the item, etc., or one or more combinations thereof.

In embodiments, the item tracing and authentication engine interface 308A may display one or more of the unique item identifiers 132, item event data 134, authentication data 136, and journey profiles 138, item journey tracking visualizations, example journey profile 138A, etc., or one or more combinations thereof, of FIG. 1.

I/O ports 310 allow client device 300 to be logically coupled to other devices including I/O components 312, some of which may be built in. Illustrative components include a microphone, joystick, game pad, satellite dish, scanner, printer, and so forth.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The term “user” as discussed herein may correspond to a human, a particular entity, a robot, another particular machine, etc.

The term “computer storage medium”excludes signals per se.

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

The term “item” may refer to a good, a tangible item, or an intangible item (e.g., computer software, an electronic document, a video of a movie, an audio of a song, an electronic photograph, artwork or another digital asset represented by a non-fungible token, an electronic gift card, an electronic theater ticket, etc.).

For purposes of a detailed discussion above, embodiments of the present technology described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the described schematics, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

Some example aspects of the technology that may be practiced from the forgoing disclosure include the following:

Aspect 1: A computer-implemented method comprising: receiving information for an item from a first client device; generating a unique item identifier for the item based on receiving the information for the item; receiving an authentication verifier for the item; linking the unique item identifier to the authentication verifier; and based on receiving a selection of the item from a second client device, providing a journey profile for the item that includes the authentication verifier.

Aspect 2: Aspect 1, further comprising: receiving a first location identifier for the item; verifying that the first location identifier corresponds to a physical location of the item; based on verifying the first location identifier, linking the unique item identifier to the first location identifier; and providing the journey profile for the item that includes the first location identifier based on linking the unique item identifier to the first location identifier.

Aspect 3: Aspect 1 or 2, further comprising: receiving a second authentication verifier for the item; linking the unique item identifier to the second authentication verifier; receiving a second location identifier for the item; verifying that the second location identifier corresponds to the physical location of the item; based on verifying the second location identifier, linking the unique item identifier to the second location identifier; and based on linking the unique item identifier to the second location identifier and the second authentication verifier, providing the journey profile for the item that includes the second location identifier and the second authentication verifier.

Aspect 4: Aspect 1, 2, or 3, further comprising: providing a map visualization that illustrates the item at a first location corresponding to the first location identifier and at a second location corresponding to the second location identifier.

Aspect 5: Aspect 1, 2, 3, or 4, further comprising: identifying a previous owner of the item based on analyzing the authentication verifier, and providing the journey profile for the item that includes information for the item associated with the previous owner.

Aspect 6: Aspect 1, 2, 3, 4, or 5, wherein the authentication verifier is analyzed using optical character recognition.

Aspect 7: Aspect 1, 2, 3, 4, 5, or 6, wherein the neural network is trained using reinforcement learning to determine the value of impropriety using the electronic transmission data for the previous electronic transmissions that are electronic payment transactions and that include both pre-authorization electronic transmission data and post-authorization electronic transmission data, the neural network being trained using a reward for subsequently blocking actual fraudulent electronic payment transactions during a pre-authorization stage associated with the actual fraudulent electronic payment transactions.

Aspect 8: Aspect 1, 2, 3, 4, 5, 6, or 7, further comprising: receiving a second authentication verifier for the item; linking the unique item identifier to the second authentication verifier; receiving a third authentication verifier for the item; linking the unique item identifier to the third authentication verifier; and based on linking the unique item identifier to the second authentication verifier and the third authentication verifier, providing the journey profile for the item that includes the second authentication verifier and the third authentication verifier.

Aspect 9: A computer system comprising: one or more processors; and a computer storage medium storing computer-useable instructions that, when used by the one or more processors, causes the computer system to perform operations comprising: receiving a selection of an item from a client device; receiving authentication data for the item; generating an authentication verifier for the item based on the authentication data; identifying a unique item identifier for the item; linking the unique item identifier to the authentication verifier; generating a journey profile for the item that includes the authentication verifier based on linking the unique item identifier to the authentication verifier; and based on receiving the selection of the item, providing the journey profile to the client device.

Aspect 10: Aspect 9, further comprising: receiving a second set of authentication data for the item; generating a second authentication verifier for the item based on the second set of authentication data; linking the unique item identifier to the second authentication verifier; and based on linking the unique item identifier to the second authentication verifier, providing the journey profile for the item that includes the second authentication verifier.

Aspect 11: Aspect 9 or 10, further comprising: identifying a plurality of previous owners of the item based on retrieving item event data corresponding to the unique item identifier; determining a gap in historical ownership of the item between at least two of the plurality of previous owners based on the item event data; and providing an indication of the gap in historical ownership of the item within the journey profile.

Aspect 12: Aspect 9, 10, or 11, further comprising: receiving a first location identifier for the item; verifying that the first location identifier corresponds to a physical location of the item; receiving a second location identifier for the item; verifying that the second location identifier corresponds to a physical location of the item; based on verifying the first location identifier and the second location identifier, linking the unique item identifier to the first location identifier and the second location identifier; and providing the journey profile for the item that includes the first location identifier and the second location identifier based on the linking.

Aspect 13: Aspect 9, 10, 11, or 12, further comprising providing a map visualization that illustrates the item at a first location corresponding to the first location identifier and at a second location corresponding to the second location identifier.

Aspect 14: Aspect 9, 10, 11, 12 or 13, further comprising: receiving a second set of authentication data for the item; determining the second set of authentication data has missing authentication data for the item; and providing an indication of the missing authentication data.

Aspect 15: One or more non-transitory computer storage media storing computer-useable instructions that, when used by one or more processors, cause the one or more processors to perform operations comprising: identifying a unique item identifier for an item; linking the unique item identifier to an authentication verifier for the item; generating a journey profile for the item that includes the authentication verifier based on linking the unique item identifier to the authentication verifier; receiving a selection, by a client device, to view the journey profile; and based on receiving the selection, causing to provide the journey profile to the client device.

Aspect 16: Aspect 15, further comprising: identifying a plurality of historical location identifiers for the item based on retrieving item event data corresponding to the unique item identifier; linking the unique item identifier to each of the plurality of historical location identifiers; and causing to provide the journey profile for the item that includes the plurality of historical location identifiers based on linking the unique item identifier to each of the plurality of historical location identifiers.

Aspect 17: Aspect 15 or 16, further comprising: determining a gap in historical locations based on the item event data between at least two of the plurality of historical location identifiers; and causing to provide an indication of the gap in historical locations within the journey profile.

Aspect 18: Aspect 15, 16, or 17, further comprising: identifying a plurality of previous owners of the item based on retrieving item event data corresponding to the unique item identifier; determining a gap in historical ownership of the item between at least two of the plurality of previous owners based on the item event data; and causing to provide an indication of the gap in historical ownership of the item within the journey profile.

Aspect 19: Aspect 15, 16, 17, or 18, further comprising: generating the authentication verifier for the item based on receiving authentication data; receiving a second set of authentication data for the item; determining the second set of authentication data has missing authentication data for the item; and causing to provide an indication of the missing authentication data.

Aspect 20: Aspect 15, 16, 17, 18, or 19, the operations further comprising: causing to provide a map visualization that illustrates the item at a plurality of locations corresponding to the plurality of historical location identifiers.

1. A computer-implemented method comprising:
receiving information for an item from a first client device;
generating a unique item identifier for the item based on receiving the information for the item;
receiving an authentication verifier for the item;
linking the unique item identifier to the authentication verifier; and
based on receiving a selection of the item from a second client device, providing a journey profile for the item that includes the authentication verifier.

2. The computer-implemented method of claim 1, further comprising:
receiving a first location identifier for the item;
verifying that the first location identifier corresponds to a physical location of the item;
based on verifying the first location identifier, linking the unique item identifier to the first location identifier; and
providing the journey profile for the item that includes the first location identifier based on linking the unique item identifier to the first location identifier.

3. The computer-implemented method of claim 2, further comprising:
receiving a second authentication verifier for the item;
linking the unique item identifier to the second authentication verifier;
receiving a second location identifier for the item;
verifying that the second location identifier corresponds to the physical location of the item;
based on verifying the second location identifier, linking the unique item identifier to the second location identifier; and
based on linking the unique item identifier to the second location identifier and the second authentication verifier, providing the journey profile for the item that includes the second location identifier and the second authentication verifier.

4. The computer-implemented method of claim 3, further comprising providing a map visualization that illustrates the item at a first location corresponding to the first location identifier and at a second location corresponding to the second location identifier.

5. The computer-implemented method of claim 1, further comprising identifying a previous owner of the item based on analyzing the authentication verifier, and providing the journey profile for the item that includes information for the item associated with the previous owner.

6. The computer-implemented method of claim 1, further comprising providing an indication to the second client device that the authentication verifier of the journey profile is valid based on analyzing the authentication verifier.

7. The computer-implemented method of claim 6, wherein the authentication verifier is analyzed using optical character recognition.

8. The computer-implemented method of claim 1, further comprising:
receiving a second authentication verifier for the item;
linking the unique item identifier to the second authentication verifier;
receiving a third authentication verifier for the item;
linking the unique item identifier to the third authentication verifier; and
based on linking the unique item identifier to the second authentication verifier and the third authentication verifier, providing the journey profile for the item that includes the second authentication verifier and the third authentication verifier.

9. A computer system comprising:
one or more processors; and
a computer storage medium storing computer-useable instructions that, when used by the one or more processors, causes the computer system to perform operations comprising:
receiving a selection of an item from a client device;
receiving authentication data for the item;
generating an authentication verifier for the item based on the authentication data;
identifying a unique item identifier for the item;
linking the unique item identifier to the authentication verifier;
generating a journey profile for the item that includes the authentication verifier based on linking the unique item identifier to the authentication verifier; and
based on receiving the selection of the item, providing the journey profile to the client device.

10. The computer system of claim 9, the operations further comprising:
receiving a second set of authentication data for the item;
generating a second authentication verifier for the item based on the second set of authentication data;
linking the unique item identifier to the second authentication verifier; and
based on linking the unique item identifier to the second authentication verifier, providing the journey profile for the item that includes the second authentication verifier.

11. The computer system of claim 9, the operations further comprising:
identifying a plurality of previous owners of the item based on retrieving item event data corresponding to the unique item identifier;
determining a gap in historical ownership of the item between at least two of the plurality of previous owners based on the item event data; and
providing an indication of the gap in historical ownership of the item within the journey profile.

12. The computer system of claim 9, the operations further comprising:
receiving a first location identifier for the item;
verifying that the first location identifier corresponds to a physical location of the item;
receiving a second location identifier for the item;
verifying that the second location identifier corresponds to a physical location of the item;
based on verifying the first location identifier and the second location identifier, linking the unique item identifier to the first location identifier and the second location identifier; and
providing the journey profile for the item that includes the first location identifier and the second location identifier based on linking the unique item identifier to the first location identifier and the second location identifier.

13. The computer system of claim 12, providing a map visualization that illustrates the item at a first location corresponding to the first location identifier and at a second location corresponding to the second location identifier.

14. The computer system of claim 9, the operations further comprising:
receiving a second set of authentication data for the item;
determining the second set of authentication data has missing authentication data for the item; and
providing an indication of the missing authentication data.

15. One or more non-transitory computer storage media storing computer-useable instructions that, when used by one or more processors, cause the one or more processors to perform operations comprising:
identifying a unique item identifier for an item;
linking the unique item identifier to an authentication verifier for the item;
generating a journey profile for the item that includes the authentication verifier based on linking the unique item identifier to the authentication verifier;
receiving a selection, by a client device, to view the journey profile; and
based on receiving the selection, causing to provide the journey profile to the client device.

16. The one or more non-transitory computer storage media of claim 15, the operations further comprising:
identifying a plurality of historical location identifiers for the item based on retrieving item event data corresponding to the unique item identifier;
linking the unique item identifier to each of the plurality of historical location identifiers; and
causing to provide the journey profile for the item that includes the plurality of historical location identifiers based on linking the unique item identifier to each of the plurality of historical location identifiers.

17. The one or more non-transitory computer storage media of claim 16, the operations further comprising:
determining a gap in historical locations based on the item event data between at least two of the plurality of historical location identifiers; and
causing to provide an indication of the gap in historical locations within the journey profile.

18. The one or more non-transitory computer storage media of claim 15, the operations further comprising:
identifying a plurality of previous owners of the item based on retrieving item event data corresponding to the unique item identifier;
determining a gap in historical ownership of the item between at least two of the plurality of previous owners based on the item event data; and
causing to provide an indication of the gap in historical ownership of the item within the journey profile.

19. The one or more non-transitory computer storage media of claim 15, the operations further comprising:
generating the authentication verifier for the item based on receiving authentication data;
receiving a second set of authentication data for the item;
determining the second set of authentication data has missing authentication data for the item; and
causing to provide an indication of the missing authentication data.

20. The one or more non-transitory computer storage media of claim 16, the operations further comprising: causing to provide a map visualization that illustrates the item at a plurality of locations corresponding to the plurality of historical location identifiers.
